(19) United States
(12) Patent Application Publication
(10) Pub. No.: US 2016/0239000 A1
(43) Pub. Date: Aug. 18, 2016

(54) TS-DIST: Learning Adaptive Distance Metric in Time Series Sets

(71) Applicant: NEC Laboratories America, Inc., Princeton, NJ (US)

(72) Inventors: Tan Yan, Bedminster, NJ (US); Haifeng Chen, Old Bridge, NJ (US); Guofei Jiang, Princeton, NJ (US)

(21) Appl. No.: 15/003,395

(22) Filed: Jan. 21, 2016

Related U.S. Application Data
(60) Provisional application No. 62/115,184, filed on Feb. 12, 2015.

(51) Int. Cl. G05B 13/02; G06F 17/11

(52) U.S. Cl. CPC G05B 13/0265; G06F 17/11

(57) ABSTRACT

A process to control a machine by receiving data captured from one or more sensors in the machine generating high-dimensional time series sets in a machine; performing structure precomputing to obtain structures of different sets and time series in each set; performing supervised distance learning by imposing label information to the obtained structures, learning a transformation matrix; transforming the data to shrink a distance between sets with the same label and to stretch the distance between sets with different labels; and applying the transformed data to control the machine responsive to the time series data.

This application claims priority to Provisional Application Ser. 62/115,184, the content of which is incorporated by reference.

### BACKGROUND

The present invention relates to analyzing time-series data and controlling machines thereof.

Time series contains rich information that can be used to describe the sequential observation of events, such as operations of physical machine, human activities, and financial markets. With the support of various types of sensors, nowadays, multiple events can be monitored and collected simultaneously, which generates multiple time series at the same time, named time series set, and multiple sets are generated if such monitoring is repeated. While such time series sets possess even richer information, to analyze them is very challenging. First, the time series sets usually have complicated structures, and strong dependencies between each other. Even inside each set, the time series have strong relationship with each other as they are essentially from different components of the same object. Second, although the time series from different components can be automatically collected, due to the cost and the lack of the knowledge, it is hard to label each time series individually but only the whole set. This makes having a meaningful and discriminative distance measurement in time series sets a challenging task due to their complex structures and dependencies.

Traditional distance metrics, e.g., time warping, examine the data in a unsupervised fashion, which calculate the distance to differentiate the data based on the given features. However, in time series set, due to its huge structural complexity and weak label information, the possible discriminative features are usually deeply masked under the complex structures. Thus the distance between different sets becomes flat and not meaningful, and the boundary between sets with different labels becomes indistinguishable. Under such distance metrics, it is difficult to differentiate different time series sets and impose label information to supervise the analysis, e.g., classification.

### SUMMARY

A process to control a machine by receiving data captured from one or more sensors in the machine generating high-dimensional time series sets in a machine; performing structure precomputing to obtain structures of different sets and time series in each set; performing supervised distance learning by imposing label information to the obtained structures, learning a transformation matrix; transforming the data to shrink a distance between sets with the same label and to stretch the distance between sets with different labels; and applying the transformed data to control the machine responsive to the time series data.

Advantages may include one or more of the following. The method will produce high quality results to learn a good distance metric to differentiate time series sets based on their labels. It helps analyze data collected from physical systems, cars, manufacture systems, and financial markets, etc. The output of our invention is a low-dimension matrix representing the high-dimensional input time series. It has clear separation between data with different labels, which greatly helps the further analysis, e.g., classification, of the data and drastically reduces the data size; while at the same time preserves the structures and dependencies of the original input. Such an adaptive distance learning engine gives a clear separation for data with different labels, which helps system engineers to diagnose the system and predict the future performance and status of the system. The system provides metrics with the following features: (1) Adaptiveness. The metric needs to be adaptively learned according to the given data, and reflect the structure of the input data. (2) Global distinguishability. The metric needs to make sets with the same labels more similar and sets with different labels more different. (3) Local relative structures. Under the metric, the original local neighborhood relationships need to be maintained.

### BRIEF DESCRIPTION OF THE DRAWINGS

FIG. 1A shows a machine with sensors and actuators with a learning engine, such as those present in an exemplary chemical plant.

FIG. 1B shows an exemplary workflow of a distance learning engine in the system of FIG. 1A.

FIG. 2 shows an exemplary process to form a projected matrix with preserved structures.

FIG. 3 shows an exemplary process to transform a matrix with a desired distance metric.

FIG. 4 shows exemplary details of the structure pre-computing operation.

FIG. 5 shows exemplary details of the supervised distance learning operation.

FIG. 6 shows an exemplary processing system to which the present principles may be applied, in accordance with an embodiment of the present principles.

FIG. 7 shows a high level diagram of an exemplary physical system including the learning engine, in accordance with an embodiment of the present principles.

### DESCRIPTION

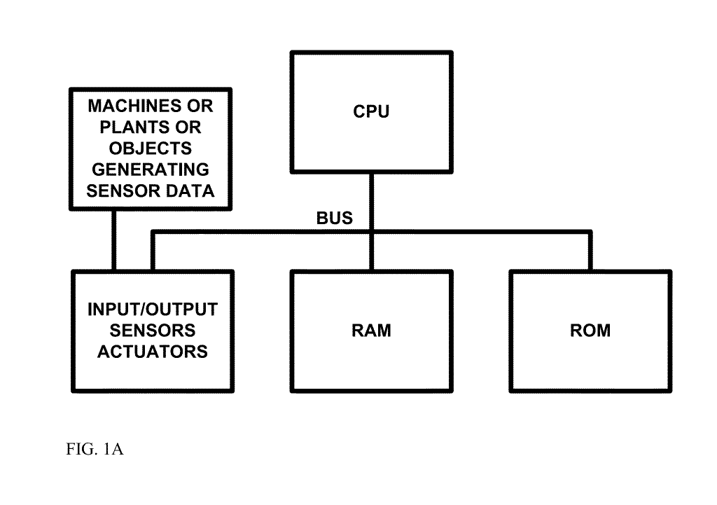

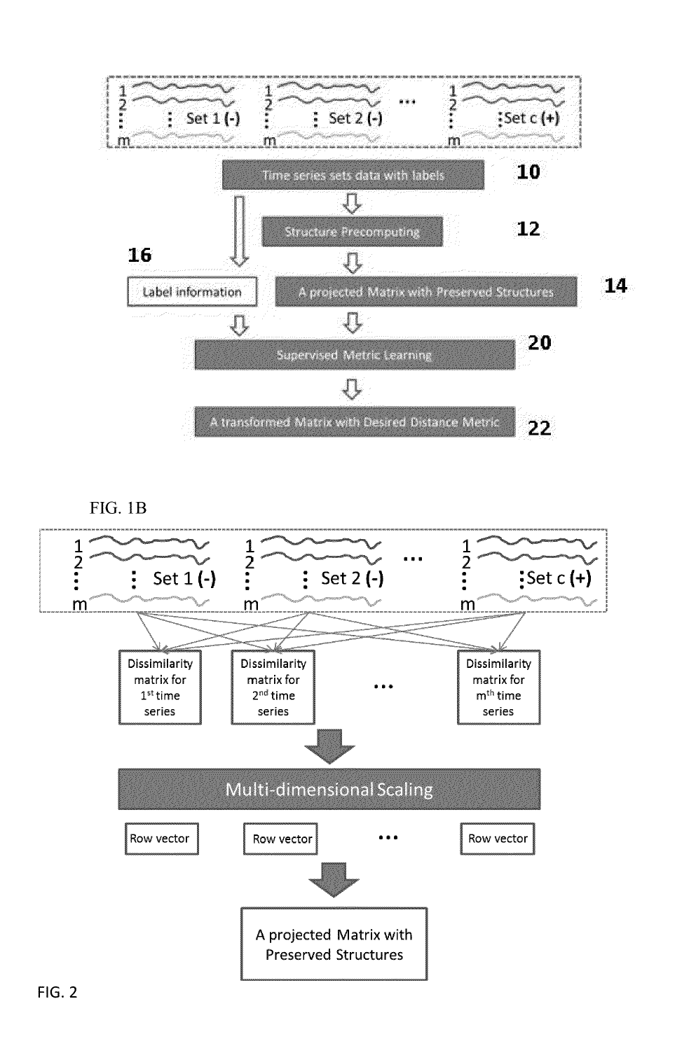

The invention may be implemented in hardware, firmware or software, or a combination of the three. FIG. 1A shows an exemplary computer to process time series data from sensors and operating actuators in response thereto. Preferably the invention is implemented in a computer program executed on a programmable computer having a processor, a data storage system, volatile and non-volatile memory and/or storage elements, at least one input device and at least one output device. This system can be used for preprocessing sensor data, as sensor data often comes with noise and high dimensionality, making it difficult to analyze and find out the characteristics that can indicate performance. By using the present technique, multi-dimensional time series can be projected to a new space where instance with different behaviors/status/performance are clearly separated, so that it facilitates the further analysis, e.g., classification. For example, in chemical plants, we may to learn a classification model based on time series collected from different parts of the system to classify products with different key performance indicators or KPIs. However, such massive time series data is noisy, and useful information is often hidden deeply inside the data. If we directly apply classification model on the data, the accuracy of the model will be poor because it cannot determine characteristics that differentiate the KPIs. Our system can preprocess such time series by first clearly separating them according to training labels, where instance with different labels are well distinguished. Next, the classification model is trained on such preprocessed time series and the trained or learned model has better classification accuracy.

By way of example, a block diagram of a system with sensors capturing data for the learning engine of FIG. 1B is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. For example, the I/O interface can receive data from sensors. In the broadest definition, a sensor is an object whose purpose is to detect events or changes in its environment, and then provide a corresponding output. A sensor is a type of transducer; sensors may provide various types of output, but typically use electrical or optical signals. For example, a thermocouple generates a known voltage (the output) in response to its temperature (the environment). A mercury-in-glass thermometer, similarly, converts measured temperature into expansion and contraction of a liquid, which can be read on a calibrated glass tube. Sensors are used in everyday objects such as touch-sensitive elevator buttons (tactile sensor) and lamps which dim or brighten by touching the base, besides innumerable applications of which most people are never aware. With advances in micro machinery and easy-to-use micro controller platforms, the uses of sensors have expanded beyond the most traditional fields of temperature, pressure or flow measurement sensors. Moreover, analog sensors such as potentiometers and force-sensing resistors are still widely used. Applications include manufacturing and machinery, airplanes and aerospace, cars, medicine, and robotics, among others. A sensor's sensitivity indicates how much the sensor's output changes when the input quantity being measured changes. For instance, if the mercury in a thermometer moves 1 cm when the temperature changes by 1° C., the sensitivity is 1 cm/° C. (it is basically the slope Dy/Dx assuming a linear characteristic). Some sensors can also have an impact on what they measure; for instance, a room temperature thermometer inserted into a hot cup of liquid cools the liquid while the liquid heats the thermometer.

The I/O interface can also control actuators such as motors. An actuator is a type of motor that is responsible for moving or controlling a mechanism or system. It is operated by a source of energy, typically electric current, hydraulic fluid pressure, or pneumatic pressure, and converts that energy into motion. An actuator is the mechanism by which a control system acts upon an environment. The control system can be simple (a fixed mechanical or electronic system), software-based (e.g. a printer driver, robot control system), a human, or any other input. A hydraulic actuator consists of cylinder or fluid motor that uses hydraulic power to facilitate mechanical operation. The mechanical motion gives an output in terms of linear, rotary or oscillatory motion. Because liquids are nearly impossible to compress, a hydraulic actuator can exert considerable force. The drawback of this approach is its limited acceleration. The hydraulic cylinder consists of a hollow cylindrical tube along which a piston can slide. The term single acting is used when the fluid pressure is applied to just one side of the piston. The piston can move in only one direction, a spring being frequently used to give the piston a return stroke. The term double acting is used when pressure is applied on each side of the piston; any difference in pressure between the two side of the piston moves the piston to one side or the other. Pneumatic rack and pinion actuators for valve controls of water pipes. A pneumatic actuator converts energy formed by vacuum or compressed air at high pressure into either linear or rotary motion. Pneumatic energy is desirable for main engine controls because it can quickly respond in starting and stopping as the power source does not need to be stored in reserve for operation. Pneumatic actuators enable large forces to be produced from relatively small pressure changes. These forces are often used with valves to move diaphragms to affect the flow of liquid through the valve An electric actuator is powered by a motor that converts electrical energy into mechanical torque. The electrical energy is used to actuate equipment such as multi-turn valves. It is one of the cleanest and most readily available forms of actuator because it does not involve oil. Actuators which can be actuated by applying thermal or magnetic energy have been used in commercial applications. They tend to be compact, lightweight, economical and with high power density. These actuators use shape memory materials (SMMs), such as shape memory alloys (SMAs) or magnetic shape-memory alloys (MSMAs). A mechanical actuator functions by converting rotary motion into linear motion to execute movement. It involves gears, rails, pulleys, chains and other devices to operate. An example is a rack and pinion.

Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

FIG. 1B shows an exemplary workflow of our distance learning engine called TS-Dist. First, our process receives time series data with labels (10). Structure Precomputing is performed (12), as detailed below. Our process generates a projected matrix with preserved structures (14), and label information is retrieved (16). The label information and projected matrix is provided to a supervised metric learning method (20). A transformed matrix is generated with a desired distance metric (22).

The Structure Precomputing operation examines all high-dimensional time series sets and captures the structures of different sets and time series in each set. The Supervised Distance Learning imposes the label information to the obtained structures, learns a transformation matrix, and transforms the data to shrink the distance between sets with the same label while stretch the distance between sets with different labels. More specifically, in the step of Structure Precomputing, we treat each type of time series in the sets as a feature and obtain the structure dependency between different time series sets. For each type of time series, we analyze it across all the sets and compute the dissimilarity matrix based on this feature. After that, we use Multidimensional Scaling (MDS) to project each of the calculated dissimilarity matrix to a row vector. Each projected vector corresponds to a time series feature, which represents the coordinates of the input time series sets along this feature. We do this for all the time series, each obtaining a row vector of the MDS coordinates along the corresponding time series feature. We assemble all the row vectors and obtain a matrix, where each column stores the coordinates of the corresponding original time series set along all the features. In this way, we project the high dimensional time series sets into a low-dimensional matrix while at the same time capture the structure across all the sets. The obtained matrix from the Structure Precomputing step is the input of the Supervised Distance Learning step. In this step, to maintain original local neighborhood relationship, we adapt the idea of k Nearest Neighbors (kNN) and make each time series set identify its kNN from sets with the same labels based on the information of the input MDS matrix. To achieve good separation between sets with different labels, we learn a linear transformation matrix that projects the input matrix to a new space, such that each set is closer to its identified kNN than sets with different labels. We adopt the idea of Largest Margin Nearest Neighbor (LMNN) to formulate the underlying problem to a Semi-Definite Programming (SDP) problem that can be solved with existing well-known methods. We then solve the SDP problem, obtain the learnt transformation matrix, and project the input MDS matrix to a new space where the desired distance metric is defined. We apply the designed TS-Dist to a real-world data set. The experiment shows our distance metric can greatly help separate the time series sets with different labels and achieved much higher classification accuracy than the compared baseline schemes.

In one engine receiving c time series sets each containing m types of time series, the engine solves the problem in two major steps: (1) Structure Precomputing and (2) Supervised Metric Learning. In Structure Precomputing, to obtain the global dependency across all the time series sets, for each time series type, we extract the time series from all the sets, one out of each, and construct a new set. In total, we obtain m such sets for all m types of time series, each containing c time series. Then, for each of those sets, we compute its dissimilarity matrix by calculating the pair-wised distance for each time series in the set. We develop a library of distance functions, such as Euclidean distance and dynamic time warping, etc, for doing this computation depending on the property of the time series. For each type of the time series, the corresponding dissimilarity matrix contains the dependency and similarity across all the time series sets, using this type of time series as a feature. We compute the dissimilarity matrix for all the m time series types, and obtain m dissimilarity matrix. After that, we project dependency and similarity captured in each dissimilarity matrix to a vector. We apply Multi-dimensional Scaling (MDS) to each computed dissimilarity matrix project it to a row vector, and obtain m such vectors for m similarity sets. We then bind the vectors by row and construct a projected matrix and associate the time series set labels to each vector in such a matrix. The detailed flow of this step is shown in FIG. 2.

TS-Dist learns a transformation matrix, in which a distance metric is defined to make sets with the same labels more similar and sets with different labels more different, and at the same time maintain their local structures. TS-Dist aims to adaptively learn a metric from the input time series sets and their labels, which maximizes the distance between sets with different labels and minimize the distance between ones with the same label, and at the same time maintain their local structures.

Our design breaks the learning process of TS-Dist into two steps: (1) Structure Precomputing, which examines all the high-dimensional time series sets and capture the structures of different sets and time series in each set. (2) Supervised Distance Learning, which imposes the label information to the obtained structures, learns a transformation matrix, and transforms the data to shrink the distance between sets with the same label while stretch the distance between sets with different labels.

More specifically, in the step of Structure Precomputing, we treat each type of time series in the sets as a feature and obtain the structure dependency between different time series sets. For each type of time series, we analyze it across all the sets and compute the dissimilarity matrix based on this feature. After that, we use Multidimensional Scaling (MDS) to project each of the calculated dissimilarity matrix to a row vector. Each projected vector corresponds to a time series feature, which represents the coordinates of the input time series sets along this feature. We do this for all the time series, each obtaining a row vector of the MDS coordinates along the corresponding time series feature. We assemble all the row vectors and obtain a matrix, where each column stores the coordinates of the corresponding original time series set along all the features. In this way, we project the high dimensional time series sets into a low-dimensional matrix while at the same time capture the structure across all the sets.

The obtained matrix from the Structure Precomputing step is the input of the Supervised Distance Learning step. In this step, to maintain original local neighborhood relationship, we adapt the idea of k Nearest Neighbors (kNN) and make each time series set identify its kNN from sets with the same labels based on the information of the input MDS matrix. To achieve good separation between sets with different labels, we learn a linear transformation matrix that projects the input matrix to anew space, such that each set is closer to its identified kNN than sets with different labels. We formulate the underlying problem to a Semi-Definite Programming (SDP) problem that can be solved with existing well-known methods. We then solve the SDP problem, obtain the learnt transformation matrix, and project the input MDSmatrix to a new space where the desired distance metric is defined.

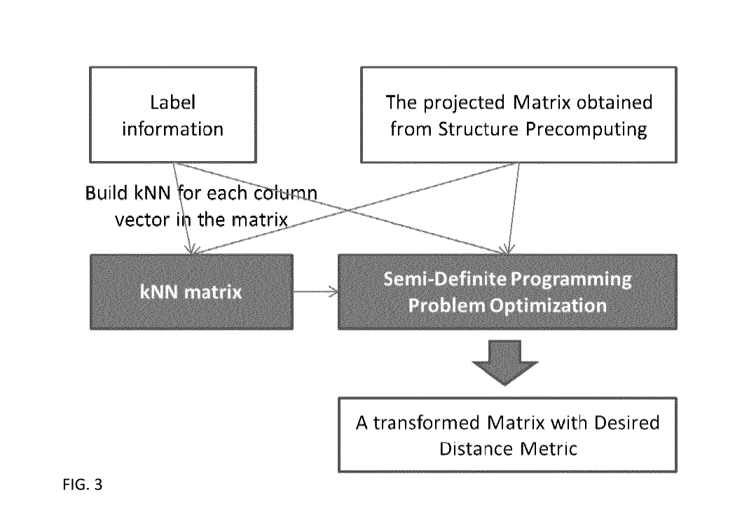

The projected matrix preserves the structures and dependencies of the raw input time series sets, and represents the raw input time series sets in low dimension. The matrix and the corresponding labels are the input to the second step of the TS-Dist, Supervised Metric Learning. In Supervised Metric Learning, we transform the matrix to another matrix of the same dimension. In the transformed matrix, we want to make the distance of vectors with the same labels to be as small as possible and vectors with different labels as large as possible, while maintain the original local relationship between vectors. To maintain the original local relationship, for each column vector in the structure matrix, we first find its kNN vectors in the matrix. To learn the discriminative distance metric, we learn a linear transformation. We convert the aforementioned distance requirement to a maximizing margin problem and formulate an objective function. We form the objective function to a Semi-Definite Programming (SDP) problem, a convex problem that can be exactly solved in polynomial time. We then solve such a SDP problem and obtain the transformed matrix. The detailed flow of this step is shown in FIG. 3.

The system provides a framework of distance metric in time series sets. We assume that each time series set contains the same number of time series, generated by the same collection of types of objects but from different observations. For example, in vehicle testing, each vehicle generates a set of time series from its tires, doors, and engine, etc. Different vehicles generate different time series sets but all from the same corresponding components of the vehicle. That is, we design TS-Dist that explicitly considers the following problem. Given a collection of c time series sets {S₁, . . . , S_{c}}, each containing m types of time series {t_{i,l}, . . . , t_{i,m}} (t_{i,k} and t_{j,k} are of the same type) and a label yᵢ (unnecessary to be binary) to the whole set, we want to learn a transformation matrix L from the data, which transforms the time series sets to a new space such that the original local neighborhood structure is maintained and each set is closer to sets with the same label and further from ones with different labels.

TS-Dist solves the problem in two major steps: (1) Structure Precomputing and (2) Supervised Metric Learning, as shown in FIG. 1. In Structure Precomputing, to obtain the global dependency across all the time series sets, for each time series type, we extract the time series from all the sets, one out of each, and construct a new set. In total, we obtain m such sets for all m types of time series, each containing c time series. Then, for each of those sets, we compute its disimilarity matrixεR^{c×c} by calculating the pairwised distance for each time series in the set. We develop a library of distance functions, such as Euclidean distance, dynamic time warping, etc, for doing this computation depending on the property of the time series. For each type of the time series, the corresponding disimilarity matrix contains the dependency and similarity across all the time series sets, using this type of time series as a feature. We compute the disimilarity matrix for all the m time series types, and obtain m disimilarity matrix. After that, we project dependency and similarity captured in each disimilarity matrix to a vector. We apply Multi-dimensional Scaling (MDS) to each computed disimilarity matrixεR^{c×c} to project it to a row vectorεR^{l×c}, and obtain m such vectors for m similarity sets. We then bind the vectors by row and construct a matrix SεR^{m×c}, and associate the time series set labels to each vector in S.

The matrix S preserves the structures and dependencies of the raw input time series sets, and represents the raw input time series sets in low dimension. S and the corresponding labels are the input to the second step of the TS-Dist, Supervised Metric Learning. In Supervised Metric Learning, we transform the matrix S to a matrix T of the same dimension. In T, we want to make the distance of vectors with the same labels to be as small as possible and vectors with different labels as large as possible, while maintain the original local relationship between vectors. To maintain the original local relationship, for each column vector in the structure matrix, we first find its kNN vectors in the matrix. To learn the discriminative distance metric, we learn a linear transformation matrix LεR^{m×m} and obtain a transformed matrix TεR^{m×c}, where T=L×S and the iₜₕ column vector in T is transformed from the iₜₕ column in S. We adopt the idea of LMNN to convert the aforementioned distance requirement to an maximizing margin problem and formulate an objective function. We formulate the objective function to a Semi-Definite Programming (SDP) problem, a convex problem that can be solved exactly in polynomial time. We then solve such a SDP problem and obtain the transformed matrix T.

In this solution, we transform each input time series set to a column vector in T, where the distances between vectors are discriminative according to their labels, and the dependencies and structures of the original input time series sets are preserved. The matrix T can be used to represent the original time series set for further analysis, such as classification.

1: Structure Precomputing

Assume we have c time series sets, each containing m time series as shown in FIG. 2, in this step, for each type of the time series, we extract it from all the sets and group them to a new set. In total, we form m new sets, each containing c time series. Then, for each formed set, we develop distance functions, such as Euclidean distance, Time Warping distance, etc., to measure the distance for each pair of the time series in the set, and form a symmetric dissimilarity matrixεR^{c×c} for it. We do this for all the new sets and obtain m dissimilarity matrices. In this way, we treat each type of the time series as a feature, and each dissimilarity matrix is a measurement of the pairwised similarity of all the input time series sets based on this feature.

To reduce the data dimension while preserving the captured global structures, we feed all the m disimilarity matrices to One-dimensional MDS and project each matrix to a row vectorεR^{l×c}. Such a vector is the one-dimensional representation of the dissimilarity matrix based on the corresponding feature, and each entry i in the vector is a coordinate of the iₜₕ original time series set. In total, we obtain m row vectors for all the m features (types of time series). After that, we assemble the row vectors to a matrix, SΣR^{m×c}, which represents the coordinates of all the time series sets in all the features. S is the final output of this step, and is the input of the second step, Supervised Distance Learning.

2: Supervised Distance Learning

In Supervised Distance Learning, we take the matrix S and the labels of original time series sets as input, and learn a discriminative distance metric according to the labels, as shown in FIG. 3.

Distance Metric Formulation:

Let {(\vec{xᵢ},yᵢ)}ᵢ₌₁^{c} denote the training samples, which are the column vectors of S with vector \vec{xᵢ} and its class label yᵢ. \vec{xᵢ} essentially represents the iₜₕ original time series set, and thus we use D(\vec{xᵢ},\vec{xⱼ}) as the measure of the distance between the iₜₕ original jₜₕ sets. We follow Mahalanobis distance formulation to define the distance function as:

D(\vec{xᵢ},\vec{xⱼ})=∥L(\vec{xᵢ}−\vec{xⱼ})∥² (1)

Distance Metric Formulation: Let {( [symbol] ,yᵢ)}ᵢ₌₁^{c} denote the training samples, which are the column vectors of S with vector xᵢ and class label yᵢ, D(x₁, xⱼ) is the measure of the distance between the iₜₕ and the jₜₕ sets. We follow Mahalanobis distance formulation to define the distance function as:

D(\vec{xᵢ},\vec{xⱼ})=∥L(\vec{xᵢ}−\vec{xⱼ})∥² (1)

Our goal is that, under such a metric as defined in Eq (1), the distance between examples with the different labels should be larger than distance between examples with the same label. We want to pull same-label examples together while push different-label examples away. The objective can be written as follows:

$$\{ \begin{matrix}D ( \vec{{x}_{i}} , \vec{{x}_{j}} ) \to small , & if {y}_{i} = {y}_{j} . \\ D ( \vec{{x}_{i}} , \vec{{x}_{l}} ) \to large , & if {y}_{i} \neq {y}_{j} . \\ D ( \vec{{x}_{i}} , \vec{{x}_{l}} ) > D ( \vec{{x}_{i}} , \vec{{x}_{i}} ) & \end{matrix} \qquad ( 2 )$$

Local Relationship Preservation with kNN:

To preserve the local neighborhood relationship in S, we apply kNN mechanism to find the k nearest neighbors for each column vector in the matrix. Then, we revise the objective in Eq (2) to make each sample pull its nearest neighbors together instead of all the samples with the same label, while still push examples with different labels away. For each sample, which is the column vector in S, we apply the developed distance functions, such as Euclidean distance or Dynamic Time Warping, to calculate the distance between this sample to all the other samples. Then, we pick the k samples with nearest distances and assign as the kNN for this sample. We do this for all the m samples in S and build a kNN matrixεR^{m×k}, where each row stores the index of its kNN.

The Objective Function:

LMNN is used to formulate the objective function and form it to a Semi-Definite Programming (SDP) problem. One exemplary objective function as shown in Eq. (3).

$$\begin{matrix}\begin{matrix}\begin{matrix}min ( 1 - μ ) {{Σ}_{i , j \to i} ( \vec{{x}_{i}} , \vec{{x}_{j}} )}^{τ} M ( \vec{{x}_{i}} , \vec{{x}_{j}} ) + {μΣ}_{i , j \to i , l} ( 1 - {y}_{i , l} ) {ξ}_{ijl} \\ s . t . {( \vec{{x}_{i}} , \vec{{x}_{l}} )}^{τ} M ( \vec{{x}_{i}} , \vec{{x}_{l}} ) - {( \vec{{x}_{i}} , \vec{{x}_{j}} )}^{τ} M ( \vec{{x}_{i}} , \vec{{x}_{j}} ) > 1 - {ξ}_{ijl}\end{matrix} \\ {ξ}_{ijl} \geq 0\end{matrix} \\ M ≽ 0\end{matrix} , \qquad ( 3 )$$

In the objective function, M≧0 means M is required to be a positive definite matrix. Under such a constraint, the optimization problem is a Semi-Definite Programming (SDP) problem, whose optimum solution can be obtained in polynomial time. We apply the mechanism used in LMNN to solve the problem and obtain the projection matrix M and the projected matrix T.

In the formulated optimization problem in Supervised Distance Learning step, there are two tunable parameters: (1) k, the number of nearest neighbors each sample finds, and (2) μ, the weight to balance pushing samples with different labels and pulling samples within its kNN. The higher k, the more samples will be pulled together during the transformation. However, setting k too high will group too many samples and make samples with same labels indistinguishable, while setting k too low will make the samples with different labels indistinguishable. For μ, the LMNN suggests to set μ=0.5 to give an equal weight between push and pull.

The matrix S obtained from the Structure Precomputing step reduces the dimension of the input time series sets to a single matrix while preserves the global structures and dependencies of the original input. Each column vector in S represents a time series set based on the features. The matrix T obtained by solving the SDP problem has the same dimension as S. Since the projection from S to T is linear, T can be seen as another representation of the original time series sets after stretching and rotation, which pushes/pulls column vectors to make their relative distances discriminative according to the labels. Such a representation transform the original time series sets to a low dimension matrix with the redefined distance metric, which reduces the size and makes the sets more distinguishable, and can greatly benefit further analysis of the data, such as classification.

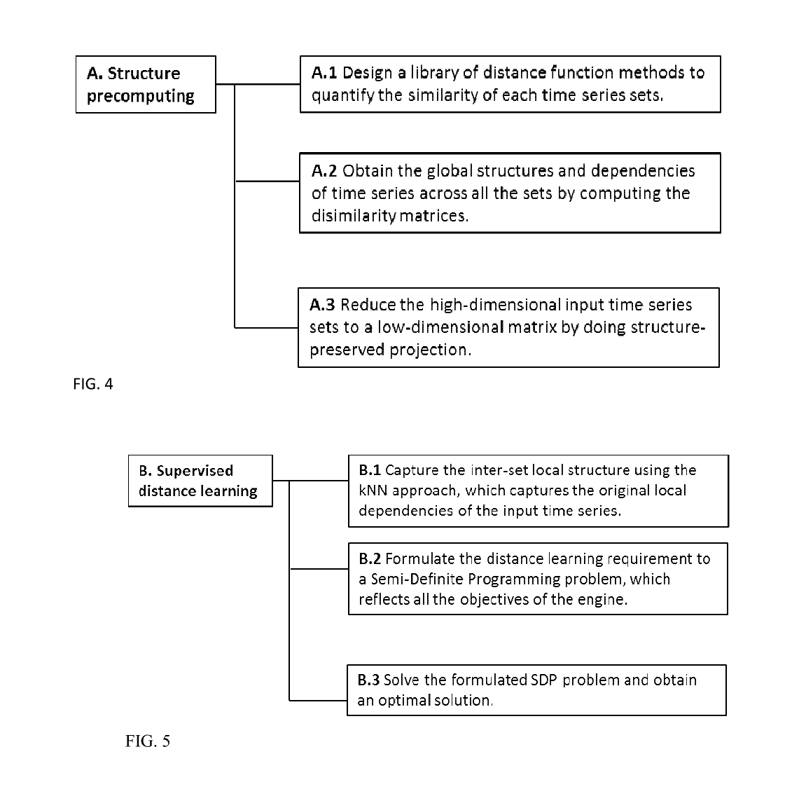

FIGS. 4-5 show exemplary operations in the structure pre-computing method and the supervised distance learning, respectively. Overall, rather than existing works that compute the distance without considering the label information, we design a distance learning framework that learns the distance metric from the labels of the input data and tries to have a clean separation for data with different labels. Different from the existing supervised learning mechanisms, our work handles high-dimensional time series set data, in which the structure is very complex and the label information is very weak. We do not directly learn the distance from the input time series sets. Instead, we perform structure-preserved projection to project the input data to a low-dimensional data while still capture the original dependencies (See FIG. 4). We formulate all the requirements and objectives in distance learning design to an objective function and solve it efficiently (See FIG. 5).

In one application, real data collected from an industrial product pipeline is analyzed. To evaluate the learned metric, we compare it with PCA and MDS, and feed the transformed data to a classifier to evaluate the classification accuracy. The data used in the evaluation is from a chemical company. Each product pipeline of the company generates a sets of time series monitored from different components of the pipeline. After the monitoring of each pipeline, domain experts give a binary label, 0 or 1, to the collected time series set to describe its state, normal or abnormal. In one experiment, after preprocessing the data, in total we collect 194 time series sets, each containing 58 time series with 163 sets with normal label and 31 sets with abnormal label. Within each set, the length of all the time series are the same, but the lengths of different time series sets can be different, ranging from 50 to 135. Therefore, the problem we want to solve during this particular study case is: given such data, how to learn a distance metric from the data, such that the sets with the same label are closer than the ones with a different label, while at the same time the local neighborhood relationship is maintained? For example, between sets with normal label, the distances should be small as their profile/behavior should be similar, while between sets with normal and abnormal labels, the distance should be large as their profile/behavior should be different. The result shows that TS-Dist has sharp contrast between the pairwised distance of sets with the same labels and the pairwised distance of sets with different labels. For PCA and MDS, the distance of all the labels are almost even, and thus it is hard to distinguish sets with different labels. To evaluate the effectiveness of the distance metric in improving the classification results, we apply the One-class SVM with precomputed kernel to the matrix learnt by TS-Dist, PCA, and MDS. Table 1 shows the training true positive and false positive rate of the three schemes for classifying the sets with normal label. From this table we can see that the true positive rate of TS-Dist is 100% while the other two schemes are both less than 60%. The false positive rate of TS-Dist is 6.1% while the other two schemes are both greater than 30%. TS-Dist helps the classifier to perform much better because it learns a discriminative distance metric based on the label to describe the relationship inside the data, makes the instances with different labels more distinguishable and their classification boundary clearer, and thus leads better results.

TABLE 1
One-Class classification result

| | True | False |
|---|---|---|
| Schemes | positive | positive |
| TS-Dist | 100% | 6.1% |
| PCA | 52% | 39% |
| MDS | 57% | 35% |

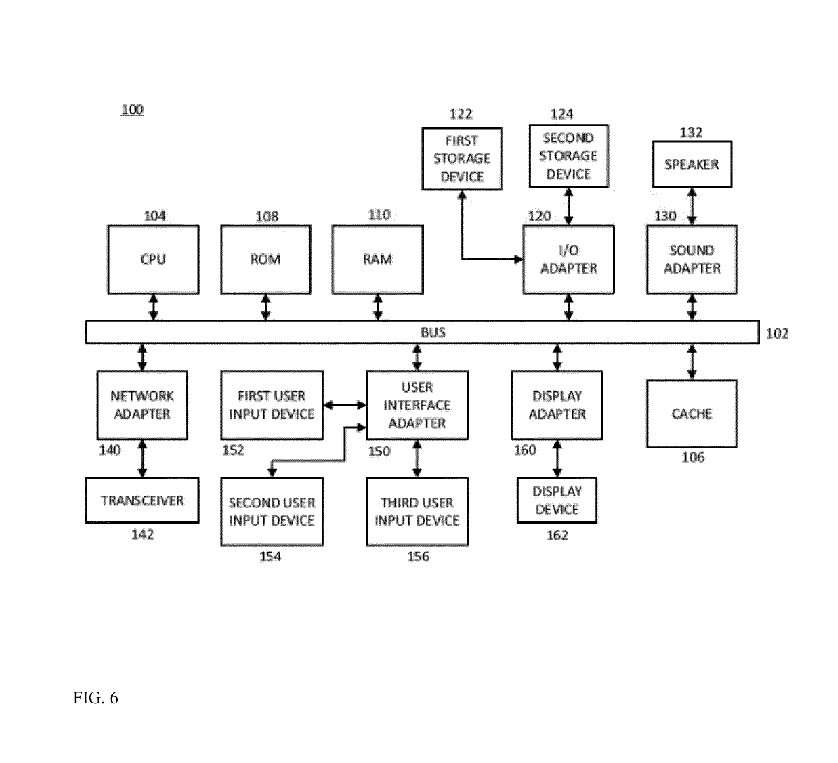

FIG. 6 with an exemplary processing system 100, to which the present principles may be applied, is illustratively depicted in accordance with an embodiment of the present principles. The processing system 100 includes at least one processor (CPU) 104 operatively coupled to other components via a system bus 102. The CPU 104 can control a machine by receiving data captured from one or more sensors in the machine generating high-dimensional time series sets in a machine; performing structure precomputing to obtain structures of different sets and time series in each set; performing supervised distance learning by imposing label information to the obtained structures, learning a transformation matrix; transforming the data to shrink a distance between sets with the same label and to stretch the distance between sets with different labels; and applying the transformed data to control the machine responsive to the time series data. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

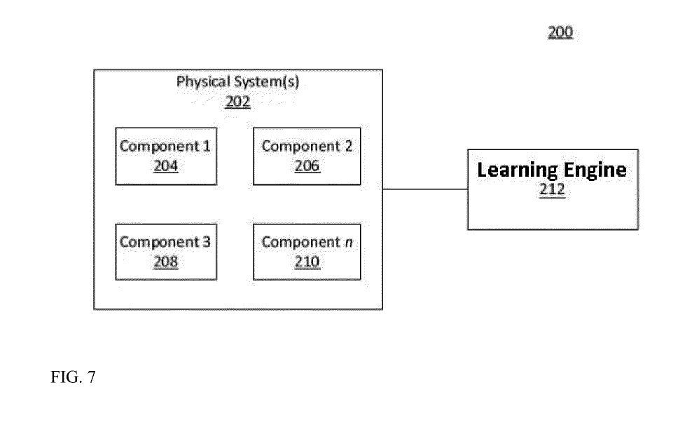

Referring now to FIG. 7, a high level schematic 200 of an exemplary physical system including a learning engine 212 is illustratively depicted in accordance with an embodiment of the present principles. In one embodiment, one or more components of physical systems 202 may be controlled and/or monitored using an archival engine 212 according to the present principles. The physical systems may include a plurality of components 204, 206, 208, 210 (e.g., Components 1, 2, 3, . . . n), for performing various system processes, although the components may also include data regarding, for example, financial transactions and the like according to various embodiments.

In one embodiment, components 204, 206, 208, and 210 may include any components now known or known in the future for performing operations in physical (or virtual) systems (e.g., temperature sensors, deposition devices, key performance indicator (KPI), pH sensors, financial data, etc.), and data collected from various components (or received (e.g., as time series)) may be employed as input to the aging profiling engine 212 according to the present principles. The archival engine/controller 212 may be directly connected to the physical system or may be employed to remotely monitor and/or control the quality and/or components of the system according to various embodiments of the present principles.

While the machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A process to control a machine, comprising:
receiving data captured from one or more sensors in the machine generating high-dimensional time series sets in a machine;
performing structure precomputing to obtain structures of different sets and time series in each set;
performing supervised distance learning by imposing label information to the obtained structures, learning a transformation matrix;
transforming the data to shrink a distance between sets with the same label and to stretch the distance between sets with different labels; and
applying the transformed data to control the machine responsive to the time series data.

2. The process of claim 1, comprising performing a structure-preserved projection that reduces the dimension and preserves dependencies of the input time series sets.

3. The process of claim 1, comprising generating a library of distance functions to quantify similarity of each time series set.

4. The process of claim 1, comprising obtaining global structures and dependencies of time series across all sets by computing dissimilarity matrices.

5. The process of claim 1, comprising reducing high dimensional time series sets to a low-dimensional matrix with a structure-preserved projection.

6. The process of claim 1, comprising capturing an inter-set local structure using k-Nearest Neighbors (kNN) to capture original local dependencies of the input time series.

7. The process of claim 1, comprising formulating a convex problem that allows the distance learning problem to be exactly solved with an optimal solution.

8. The process of claim 1, comprising formulating the distance learning requirement to a semi-definite programming (SDP) that covers all objectives.

9. The process of claim 9, comprising solving the SDP to get an optimal solution.

10. The process of claim 1, comprising applying Largest Margin Nearest Neighbor (LMNN) to formulate a Semi-Definite Programming (SDP) problem.

11. The process of claim 1, wherein the performing structure precomputing comprises treating each type of time series in the sets as a feature and obtaining structure dependency between different time series sets, and for each type of time series, analyzing the series across all sets and determining a dissimilarity matrix based on the feature.

12. The process of claim 11, comprising generating a Multidimensional Scaling (MDS) matrix to project each of the calculated dissimilarity matrix to a row vector, where each projected vector corresponds to a time series feature that represents coordinates of the input time series sets along the feature.

13. The process of claim 12, comprising assembling the row vectors and obtaining a matrix, where each column stores coordinates of corresponding original time series set along all features and projecting high dimensional time series sets into a low-dimensional matrix while at the same time capture the structure across all the sets.

14. The process of claim 11, wherein each time series set identify k Nearest Neighbors (kNN) from sets with the same labels based on information from the MDS matrix.

15. The process of claim 11, comprising learning a linear transformation matrix that projects an input matrix to a new space such that each set is closer to its identified kNN than sets with different labels.

16. The process of claim 10, comprising solving with Semi-Definite Programming (SDP), obtaining a learnt transformation matrix, and projecting the input MDS matrix to a new space where a desired distance metric is defined.

17. The process of claim 16, comprising determining an objective function as:
$$\begin{matrix}\begin{matrix}\begin{matrix}min ( 1 - μ ) {{Σ}_{i , j \to i} ( \vec{{x}_{i}} , \vec{{x}_{j}} )}^{τ} M ( \vec{{x}_{i}} , \vec{{x}_{j}} ) + {μΣ}_{i , j \to i , l} ( 1 - {y}_{i , l} ) {ξ}_{ijl} \\ s . t . {( \vec{{x}_{i}} , \vec{{x}_{l}} )}^{τ} M ( \vec{{x}_{i}} , \vec{{x}_{l}} ) - {( \vec{{x}_{i}} , \vec{{x}_{j}} )}^{τ} M ( \vec{{x}_{i}} , \vec{{x}_{j}} ) > 1 - {ξ}_{ijl}\end{matrix} \\ {ξ}_{ijl} \geq 0\end{matrix} \\ M ≽ 0\end{matrix} ,$$
where (1−y_{i,l}) is effective when y_{i,l}=0, meaning yᵢ≠yₗ and xₗ [symbol] not a kNN of xᵢ, k is a number of nearest neighbors in each sample, and μ is a weight to balance pushing samples with different labels and pulling samples within its kNN.

18. A system, comprising:
an actuator;
one or more sensors generating high-dimensional time series sets;
a processor executing code for:
performing structure precomputing to obtain structures of different sets and time series in each set;
performing supervised distance learning by imposing label information to the obtained structures, learning a transformation matrix;
transforming the data to shrink a distance between sets with the same label and to stretch the distance between sets with different labels; and
wherein the actuator is controlled by the processor for applying the transformed data to control the actuator responsive to the time series data.

19. The system of claim 18, comprising code for performing a structure-preserved projection that reduces the dimension and preserves dependencies of the input time series sets.

20. The system of claim 18, comprising code for determining an objective function as:
$$\begin{matrix}\begin{matrix}\begin{matrix}min ( 1 - μ ) {{Σ}_{i , j \to i} ( \vec{{x}_{i}} , \vec{{x}_{j}} )}^{τ} M ( \vec{{x}_{i}} , \vec{{x}_{j}} ) + {μΣ}_{i , j \to i , l} ( 1 - {y}_{i , l} ) {ξ}_{ijl} \\ s . t . {( \vec{{x}_{i}} , \vec{{x}_{l}} )}^{τ} M ( \vec{{x}_{i}} , \vec{{x}_{l}} ) - {( \vec{{x}_{i}} , \vec{{x}_{j}} )}^{τ} M ( \vec{{x}_{i}} , \vec{{x}_{j}} ) > 1 - {ξ}_{ijl}\end{matrix} \\ {ξ}_{ijl} \geq 0\end{matrix} \\ M ≽ 0\end{matrix} ,$$
where (1−y_{i,l}) is effective when y_{i,l}=0, meaning yᵢ≠yₗ and xₗ is not a kNN of xᵢ, k is a number of nearest neighbors in each sample, and μ is a weight to balance pushing samples with different labels and pulling samples within its kNN.
